(19) United States
(12) Patent Application Publication
(10) Pub. No.: US 2011/0121222 A1
(43) Pub. Date: May 26, 2011

(54) SYSTEMS AND METHODS FOR PROVIDING A DRY FROTH MATERIAL

(76) Inventors: Michael P. Guymon, Ogden, UT (US); Ken W. Maxwell, Sandy, UT (US)

(21) Appl. No.: 12/895,708

(22) Filed: Sep. 30, 2010

Related U.S. Application Data
(60) Provisional application No. 61/247,547, filed on Sep. 30, 2009.

(51) Int. Cl. B03D 1/001; B01D 1/22

(52) U.S. Cl. 252/61; 159/13.3

(57) ABSTRACT

A thin-film evaporation system and method for processing a wet froth material. The system includes a horizontally positioned evaporation unit having an internal conveyor screw for systematically controlling the flow of a wet froth material through the evaporator. The system further includes a separation tank configured to remove unwanted waste materials from the final, dry froth product.

### RELATED APPLICATIONS

This application claims priority to U.S. Provisional Patent Application Ser. No. 61/247,547, entitled SYSTEMS AND METHODS FOR PROVIDING A DRY FROTH MATERIAL, which was filed on Sep. 30, 2009 and is incorporated herein in its entirety by reference.

### BACKGROUND OF THE INVENTION

1. Field of the Invention

The present invention relates to systems and methods for providing a dry froth material from a wet froth intermediary produced by traditional froth flotation processes. In particular, the present invention relates to a modular system configured to include modified thin-film evaporators.

2. Background and Related Art

Oil sands, also known as tar sands or extra heavy oil, are a type of bitumen deposit. The sands are naturally occurring mixtures of sand or clay, water and are an extremely dense form of petroleum called bitumen. Oil sand deposits are found in large amounts in many countries throughout the world.

Oil sands reserves have only recently been considered to be part of the world's oil reserves. Oil sands are often referred to as unconventional oil or crude bitumen, in order to distinguish the bitumen and synthetic oil extracted from the oil sands from the free-flowing hydrocarbon mixtures known as crude oil traditionally produced from oil wells.

Conventional crude oil is normally extracted from the ground by drilling oil wells into a petroleum reservoir, allowing the oil to flow into them under natural reservoir pressures. In some cases, artificial lift techniques are used to assist in recovering the oil from the well. In contrast, oil sands flow very slowly, if at all, towards producing wells under normal reservoir conditions. Accordingly, oil sands must be extracted by strip mining or the oil must be made to flow into wells by in situ techniques which reduce the viscosity of the oil. Once recovered, the sand oil requires additional processing or upgrading to remove excess water, sand and other physical waste from the bitumen. As part of this upgrading process, some desirable products such as light volatile gasses are also removed from the bitumen. One common method of upgrading sand oil is froth flotation followed by skimming.

In the oil froth floatation process, recovered sand oil is collected in a flotation tank which is filled to capacity with water. The contents of the flotation tank are then heated and stirred. As the temperature of the sand oil increases, the viscosity of the bitumen decreases thereby increasing the flow of the bitumen material relative to the waste materials. A “collector” gas, such as compressed air is then released into the flotation tank and sufficiently intermixed with the contents therein. As the collector gas rises up through the contents of the flotation tank, the bitumen becomes aerated by the collector gas and is lifted to the surface of the tank. The frothy bituminous material is then skimmed from the top of the tank and collected as, what is termed “wet froth.”

While the oil froth flotation process removes a majority of the waste materials from the sand oil, additional upgrading of the wet froth is required. A “wet froth” material is generally defined as an intermediary oil product which predominantly contains bitumen, but also contains unacceptable amounts of water, clay and sand. Secondary upgrading processes, such as hydrotreating and hydrogenation through carbon rejection or catalytic hydrocracking are commonly used to separate the bitumen from the remaining contaminants. However, these processes are expensive and technically challenging, and they remove unwanted vacuum gas oils from the purified bitumen product.

Thus, while techniques currently exist that are used for recovering and purifying bitumen from a “wet froth” material, challenges still exist. Accordingly, it would be an improvement in the art to augment or even replace current techniques with other techniques.

### SUMMARY OF THE INVENTION

The present invention relates to systems and methods for providing a dry froth material from a wet froth intermediary produced by traditional froth flotation processes. In particular, the present invention relates to a modular system configured to include modified thin-film evaporators.

In some implementations of the present invention, a thin-film evaporator unit is provided having an internal conveyor screw configured to move a wet froth material in a desired direction through the unit. In general, the evaporation unit is provided as a means for removing water and volatile components from a wet froth material introduced into the unit. Therefore, in some implementations a heated jacket pipe/sleeve is provided as part of the evaporator unit, whereby a heated interior surface of the unit is wiped or scraped with a ribbon or screw conveyor, in concurrent or counter-concurrent flow with a carrier gas such as nitrogen, carbon dioxide or air. To accommodate the carrier gas feature, the evaporation unit is modified to include inlets and outlets for injecting and removing the carrier gas and evaporated materials.

The evaporation unit is further modified to include entrance and exit spouts to introduce and remove the wet froth material from the unit. In some implementation of the present invention, water or other volatile component of the wet froth material are removed or separated from bitumen, oil or other material where concentration of the wet froth material is desired. In other implementations, only a portion of the water and/or volatile materials are removed from the material.

The present invention further provides for a modular system of interconnected evaporation units, wherein multiple evaporation units are linked to increase the production path of the wet froth material. A longer production path may permit usage of lower production temperatures thereby reducing the possibility of thermal degradation of the materials being processed. Furthermore, in some implementation of the present invention the use of a conveyor screw permits handling of materials containing high amounts of solids without fouling or plugging the thin-film evaporation system. Thus, the material is easily moved through the evaporator and consistently applied to the heat exchange surface.

In some implementations, the conveyor screws are driven by hydraulic motors that are finely tuned and have variable speed control to decrease or increase the flow rate of the material through the system. Thus, as additional evaporation units are added to the system, the flow rate is able to be increased, as desired. Furthermore, in some implementations variable speed injection pumps are provided to increase or decrease the flow rate of materials inputted into the system.

Finally, in some implementations of the present invention, a separation tank is provided which is heat jacketed, and used either in conjunction with a thin-film evaporator or is used alone. The separation tank provides additional separation of water and volatile components from the treated or dry froth material. The separation tank includes a variable speed, reversible ribbon mixer or conveyor screw capable of moving the processed material within the tank. The tank further includes a recessed auger screw or screw conveyor capable of moving waste solids closer to, or further away from the tank outlet.

In some implementations, the ribbon mixer and the recessed auger mixer suspend and move solids away from the tank outlet while the tank is filling. When the tank is full, the auger and ribbon mixer are then turned off to allow solids to settle to the bottom of the tank. Once the solids have settled, the liquid portion (containing bitumen, oil, clay and a small amount of sand) is drained from the tank. The ribbon mixer and the auger are then reversed thereby removing solids from the tank via the tank outlet.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1A is a cross-sectioned side view of a thin-film evaporation unit in accordance with a representative embodiment of the present invention;

FIG. 1B is a cross-sectioned end view of a thin-film evaporation unit having an internal condenser in accordance with a representative embodiment of the present invention;

FIGS. 2A-2C are perspective views of various conveyor screws in accordance with representative embodiments of the present invention;

FIG. 3 is a cross-sectioned side view of a stacked configuration of evaporation units in accordance with a representative embodiment of the present invention; and

FIG. 4 is cross-sectioned view of stacked evaporation units in combination with a separator tank in accordance with a representative embodiment of the present invention.

### DETAILED DESCRIPTION OF THE INVENTION

The presently preferred embodiments of the present invention will be best understood by reference to the drawings, wherein like reference numbers indicate identical or functionally similar elements. It will be readily understood that the components of the present invention, as generally described and illustrated in the figures herein, could be arranged and designed in a wide variety of different configurations. Thus, the following more detailed description, as represented in the figures, is not intended to limit the scope of the invention as claimed, but is merely representative of presently preferred embodiments of the invention.

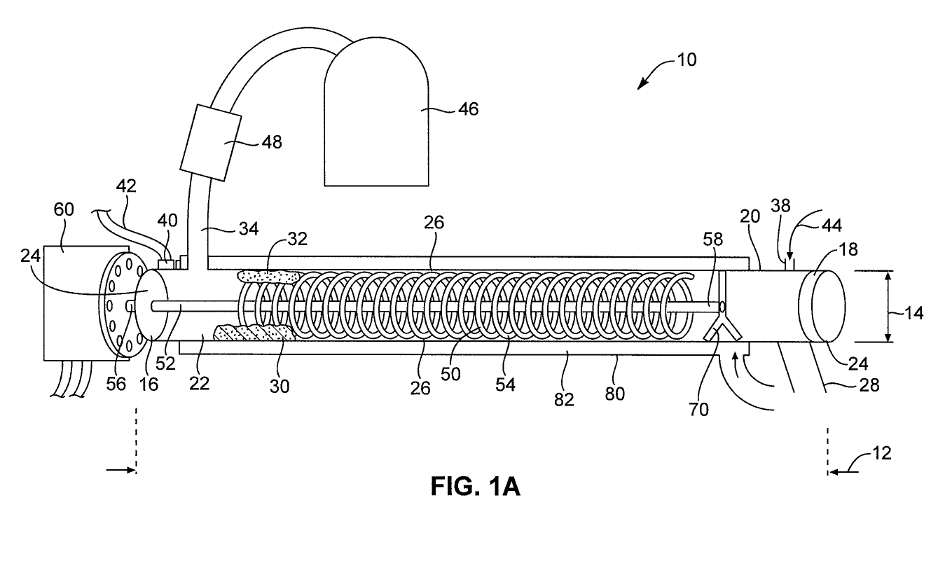

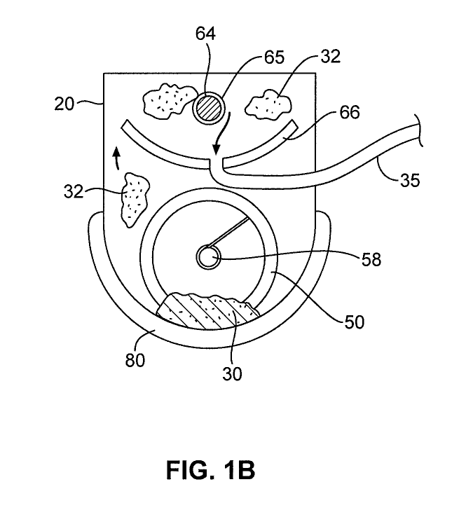

Referring now to FIG. 1A, a partially cross-sectioned view of an implementation of a horizontal thin-film evaporator 10 is shown. Thin-film evaporator 10 generally comprises a thin-film evaporation tube 20 having a length 12 and diameter 14 selected to provide a sufficient interior surface area on which to evaporate a material 30 placed within the evaporator 10. An interior lumen 22 of the evaporation tube 20 runs the length 12 of the tube and is configured to house a ribbon screw 50. In some embodiments, length 12 comprises a length from approximately one meter to greater than ten meters. In other embodiments, length 12 is selected based on a desired surface area of the lumen 22. For example, since the surface area of the lumen 22 is a function of the tube's length 12 and diameter 14, diameter 14 and length 12 may be infinitely adjusted to achieve a desired surface area.

A first end 16 of the evaporation tube 20 generally comprises a cap 24 having an access hole through which the shaft 52 of the ribbon screw 50 extends. The first end 16 further includes an opening 40 configured to receive a wet froth product 30. In some embodiments, an external pump (not shown) is used to feed the wet froth product 30 into opening 40 via conduit 42.

A second end 18 of the evaporation tube 20 comprises a cap 24 configured to seal the second end 18. A portion of the second end 18 further comprises an exit spout 28 through which the wet froth material 30 exits the tube 20 following evaporation. Finally, the second end 18 further comprises an inlet port 38 through which a carrier gas 44, such as nitrogen, carbon dioxide or compressed air is injected into the lumen 22.

Ribbon screw 50 is rotationally suspended within lumen 22. In particular, shaft 52 of ribbon screw 50 is elongated such that a first end 56 of the shaft extends through cap 24 and is coupled to hydraulic motor 60. A second end 58 of shaft 52 is similarly extended and rotationally supported within lumen 22 via stator 70. Hydraulic motor 60 is generally configured to rotate ribbon screw 50 within the evaporation tube 20 at any desired speed and direction as may be required to provide adequate treatment of the wet froth material 30.

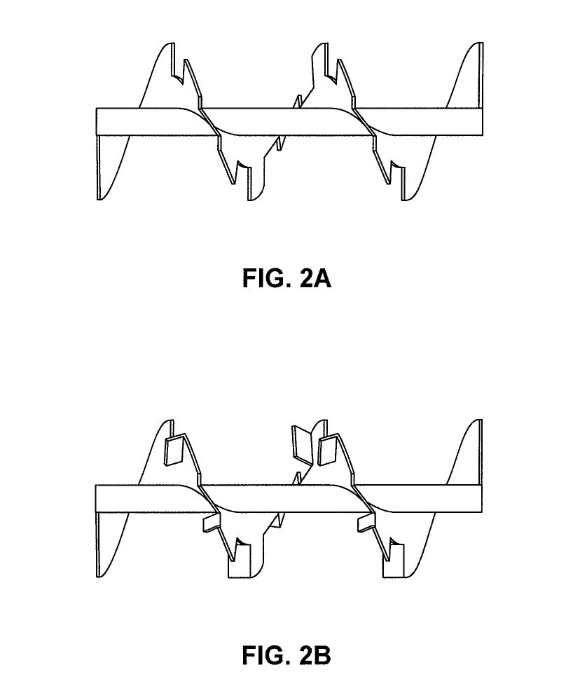

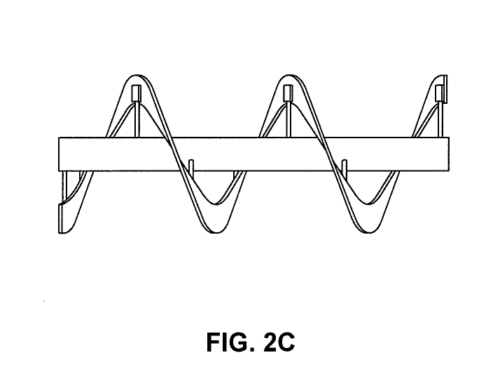

Ribbon screw 50 may include any type of conveyor screw capable of moving a wet froth material 30 through the interior lumen 22 of the evaporation tube 20. For example, in some embodiments ribbon screw 50 comprises a single cut-flight, standard pitch screw having a plurality of notches at regular intervals at an outer edge, as shown in FIG. 2A. In other embodiments, ribbon screw 50 comprises a cut and folded flight, standard pitch screw having folded flight segments configured to lift and spill the material within the lumen 22, as shown in FIG. 2B. Finally, in some embodiments ribbon screw 50 comprises a single flight ribbon screw having an open space between flighting and shaft to permit passage of material and carrier gas 44 through the lumen 22, as shown in FIG. 2C.

With continued reference to FIG. 1A, flightings 54 of ribbon screw 50 are selected to have an outer diameter slightly smaller than diameter 14 of the evaporation tube 20. As such, a small gap 26 is provided between the flightings 54 and the inner surface of the interior lumen 22. As the ribbon screw 50 is turned within the lumen 22, the wet froth material 30 is wiped away from the inner surface of the lumen 22 such that only a thin layer of the wet froth material 30 remains on the lumen surface. Thus, in some embodiments gap 26 is determined based upon a desired thickness of the thin layer deposit.

A heated jacket sleeve 80 is further provided as an external covering to evaporation tube 20. In general, jacket sleeve 80 comprises an internal lumen 82 through which a heat transfer fluid, such as oil, water or steam is circulated. The heat transfer fluid surrounds the evaporation tube 20 thereby heating the lumen 22 to a desired temperature. In some embodiments, the heat transfer fluid within jacket sleeve 80 heats lumen 22 of the evaporation tube 20 to a temperature from approximately 200° C. to greater than 800° C. Thus, when a thin layer of material 30 is deposited on the surface of the lumen 22, the thin layer of material 30 is heated by sleeve 80 to undergo evaporation thereby separating water or volatile components from the bitumen. As used herein, the term “volatile components” is used to denote high-volatile and low-volatile components of the wet froth material 30. In some embodiments, volatile components include volatile organic compounds (VOCs) which are emitted from bitumen within the wet froth material 30 during the thin-film evaporation process. Non-limiting examples of VOCs include gasoline, naphtha, diesel, kerosene, benzene, butane, ethylene, toluene, and ortho-xylene.

As the wet froth material undergoes evaporation, evaporated gases or volatile components 32 are released into the lumen 22 above the wet froth material 30. These evaporated gases 32 are removed from the lumen 22 as carrier gas 44 is injected into the lumen 22 and removed from lumen 22 via collection spout 34. Evaporated gases 32 and carrier gas 44 are subsequently collected in a condenser tank 46 for further processing and/or disposal. In some embodiments, evaporated gases 32 and carrier gas 44 are separated via a heat exchanger 48 prior to being collected and stored.

Incorporation of speed controlled ribbon screws 50 into the present invention enables higher loading of solid materials, as compared to conventional thin-film evaporators. As such, the present evaporation units are more rugged and therefore less susceptible to plugging or fouling. For example, in some embodiments the rate of rotation for ribbon screw 50 is decreased to accommodate a wet froth material 30 having increased amounts of solid materials. In other embodiments, the rate of rotation for ribbon screw 50 is increased to accommodate a wet froth material having a decreased amount of solid materials. Further, in some embodiments the rate of rotation for ribbon screw 50 is decreased to accommodate increased loading of wet froth material 30. Still further, in some embodiments the rate of rotation for ribbon screw 50 is increased to quickly process low loading of wet froth materials 30.

With reference to FIG. 1B, a cross-sectioned end view of an evaporation tube 20 is shown. In some embodiments, evaporation tube 20 is modified to include a condenser 64 located above the ribbon screw 50 and wet froth material 30. Furthermore, the evaporation unit is modified to include a u-shaped heated jacket 80, wherein only a portion of the tube 20 is surrounded by heated jacket 80. Thus, as the material 30 is heated by the transfer fluid within heated jacket 80, volatile materials 32 are separated from the material and are lifted toward the top of the tube 20. The volatile materials 32 then condense on the condenser 64 and are caught by a drip tray 66. The condensed volatile materials 65 are then removed from the tube 20 via drip tray 66 and collection tube 35, and are stored or further processed.

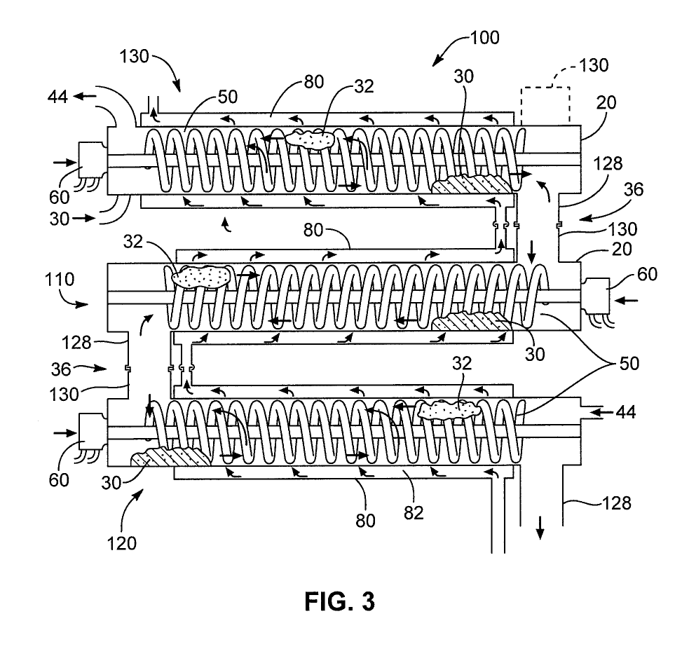

Referring now to FIG. 3, a cross-sectioned view of serially coupled, stacked horizontal thin-film evaporators 130 is shown. The stacked configuration 130 enables multiple evaporation units to be incorporated into a single system while maintaining a relatively small footprint. In some embodiments, exit spout 128 is further modified to include a coupling 36 whereby a first evaporator 100 is serially connected to a second evaporator 110. Thus, in some embodiments evaporation tube 20 is modified to include both an exit spout 128 and an entrance spout 130 (shown in phantom on the first evaporator 100), wherein a material 30 is continually processed from the first evaporator 100 to the second evaporator 110. In other embodiments, a third evaporator 120 is coupled to the exit spout 128 of the second evaporator 110, such that a material is continuously processed from the first evaporator 100 to the second evaporator 110, and from the second evaporator 110 to the third evaporator 120. One of skill in the art will appreciate that when configuring the evaporation system to include a plurality of evaporation units, the direction of each unit's ribbon screw will necessarily need to move the material 30 in the direction of the exit spout 128. One of skill in the art will also appreciate that each evaporation unit 100, 110 and 120 may be further modified and configured in a linear arrangement, rather than a stacked arrangement 130, as shown.

The ability to serially connect multiple evaporation units enables lower temperatures to be used over an extended processing path, due to longer retention times within the system. Lower processing temperatures are desirable due to reduced possibilities of thermal degradation of the materials 30 being processed.

In some embodiments, the heated jacket sleeve 80 is configured such that the heat transfer fluid within the sleeve 80 moves the fluid in a direction opposite to the movement of the material 30. Thus, as the heat transfer fluid moves serially from the third evaporator 120 towards the first evaporator 100, the temperature of the fluid will likely decrease thereby gradually decreasing the internal temperature within each evaporator. In other embodiments, the heated jacket sleeve 80 is configured such that the heat transfer fluid within the sleeve 80 moves in the same direction as the movement of the material 30. As such, the internal temperature of the first evaporator 100 will be greater than the internal temperature of the second and third evaporators 110 and 120. Further, in other embodiments the heated jacket sleeve 80 is configured such that the heated transfer fluid is delivered to each evaporator in a serial configuration, whereby the internal temperature of each evaporator is approximately the same. Still further, in some embodiments the system is configured such that each evaporator comprises a separate heated jacket sleeve 80, wherein each jacket sleeve is set at a desired temperature.

Some embodiments of the present invention provide a completely modular system of interconnected thin-film evaporation units configured to evaporate and remove water and volatile components from wet froth material. As previously discussed, some embodiments of the present invention comprise a single evaporation unit, while other embodiments comprise a plurality of stacked, interconnected evaporation units. Moreover, while FIG. 3 illustrates a representative embodiment having three evaporation units that are incorporated into a single system, other embodiments of the present invention embrace more than three evaporation units or less than three evaporation units.

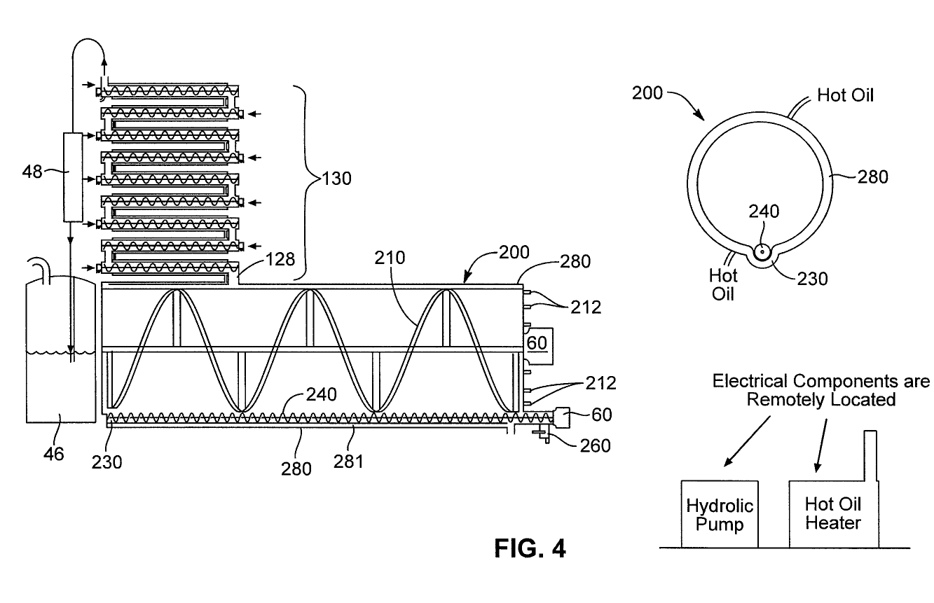

Referring now to FIG. 4, some embodiments of the present invention further include a self-cleaning mixing/separation tank 200. The separation tank 200 generally comprises a large volume container having a lumen configured to house a ribbon screw 210. In some embodiments, tank 200 is configured to hold 10,000 gallon of processed or dry froth material. The separation tank 200 comprises an entrance spout 220 configured to compatibly couple the final exit spout 128 of the stacked evaporation units 130. Thus, the dry froth material is directly deposited into the separation tank 200 from the stacked units 130.

The separation tank 200 is positioned within a heat jacket 280 such that a heated transfer fluid 281 surrounds the separation tank 200. As with the evaporation units, the heated transfer fluid heat the lumen of the separation tank 200 to a desired temperature. The ribbon screw 210 turns or agitates the dry froth material to ensure proper mixing and heating of the material. In some embodiments, the ribbon screw 210 is moved so as to direct the dry froth material away from the tank outlets 212.

As the temperature of the dry froth material increases, the viscosity of the material decreases thereby permitting the remaining waste materials to separate from the bitumen or dry froth material and settle to the bottom of the tank 200. The waste material is separated from the bitumen as the ribbon screw 210 is temporarily stopped. During this incubation period, the temperature of the dry froth material is maintained via heated transfer fluid 281. After a sufficient rest period, the dry froth material is released from the tank via the tank outlets 212.

In some embodiments, the separation tank 200 is further modified to include a concentric, recessed channel 230 located in the bottom surface of the tank 200. This channel 230 is provided such that when waste materials are separated from the dry froth material, the waste materials settle into the channel 230. Channel 230 further comprises an auger 240 whereby following removal of the dry froth product, the waste materials are removed from the channel 230 via a waste spout 260.

In some embodiments of the present invention, a dry froth product recovered from the separation tank comprises approximately 70% to 98% bitumen, 2% to 30% clay and silt, and 0% to 2% sand components. Thus, in some embodiments it may be necessary to provide a subsequent filtration or centrifugation step to further remove undesired amounts of solid components. In other embodiments, a desirable dry froth product comprises approximately 2% to 30% clay and silt.

One of skill in the art will appreciate that the thin-film evaporation units of the present invention may be implemented in field outside of the gas and oil arts. For example, in some embodiments the thin-film evaporator units and the separation tank of the present invention are used to process and prepare food products. In other embodiments, the systems and methods of the present invention are used to process and prepare materials for use in the cosmetics industries. Finally, in other embodiment the system and methods of the present invention are used to process shale oil or other types of mining product materials.

The present invention may be embodied in other specific forms without departing from its structures, methods, or other essential characteristics as broadly described herein and claimed hereinafter. Thus, the described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A thin-film evaporator device, comprising:
a first tube having a lumen for housing a conveyor screw, the conveyor screw being configured to move a material through the lumen in a desired direction at a desired rate of speed;
a heated sleeve surrounding a portion of the first tube, and a heated liquid within the heated sleeve capable of transferring a desired temperature from the heated liquid to the lumen of the first tube;
a gap interposed between the conveyor screw and an inner surface of the first tube lumen, the gap determining a thickness of film deposited on the inner surface by rotating the conveyor screw within the first tube; and
a carrier gas flowing through the lumen of the first tube, wherein the carrier gas removes an evaporated material within the lumen, the carrier gas and the removed evaporated material being stored externally to the first tube.

2. The device of claim 1, wherein the first tube further comprises a port whereby the evaporated material and the carrier gas are removed from the lumen of the first tube.

3. The device of claim 1, wherein the material comprises a dry froth material.

4. The device of claim 1, wherein the evaporated material comprises a volatile component.

5. The device of claim 1, further comprising a heat exchanger.

6. The device of claim 1, further comprising a second tube having a lumen for housing a second conveyor screw, the second conveyor screw being configured to move the material through the lumen of the second tube in a desired direction at a desired rate of speed, the second tube having an input in fluid communication with an output of the first tube, wherein the material exits the first tube through the output into the input of the second tube.

7. The device of claim 6, wherein the heated sleeve further surrounds a portion of the second tube.

8. The device of claim 6, wherein the carrier gas flows through the second tube prior to flowing through the first tube.

9. The device of claim 6, further comprising a plurality of tubes fluidly interconnected via a plurality of inputs and a plurality of outputs, wherein the material is sequentially moved through the plurality of tubes to remove the evaporated material from the material.

10. A separation tank device, comprising:
a first tube having a first lumen for housing a first conveyor screw, the conveyor screw being configured to move a material through the first lumen in a desired direction at a desired rate of speed;
a second tube forming a portion of the first tube, the second tube having a second lumen in fluid communication with the first lumen, the second lumen being configured to house a second conveyor screw configured to move a material through the second lumen in a desired direction at a desired rate of speed;
a heated sleeve surrounding a portion of the first and second tubes, and a heated liquid within the heated sleeve capable of transferring a desired temperature from the heated liquid to the lumens of the first and second tubes.

11. The device of claim 10, further comprising a thin-film evaporation tube having an output in fluid communication with the first lumen of the first tube, wherein the material is delivered to the first lumen via the output of the thin-film evaporator tube.

12. The device of claim 11, wherein the thin-film evaporation tube comprises a plurality of fluidly interconnected thin-film evaporation tubes.

13. The device of claim 10, wherein the thin-film evaporation tube removes an evaporated material from the material prior to delivering the material to the first lumen.

14. The device of claim 13, wherein the evaporated material is a volatile component.

15. The device of claim 10, wherein the first tube further comprises an output whereby to remove a dry froth material from the first lumen, and wherein the second tube further comprises an output whereby to remove a waste material from the second lumen.

16. The device of claim 15, further comprising a collection tank fluidly coupled to the output of the first tube.

17. A dry froth composition, comprising:
a bitumen component from approximately 70% w/v to approximately 98% w/v;
a clay and silt component from approximately 2% w/v to approximately 30% w/v; and
a sand component from approximately 0% w/v to approximately 2% w/v.

18. The composition of claim 17, wherein the bitumen component comprises a volatile component.

19. The composition of claim 18, wherein the volatile component evaporates at a temperature from approximately 200° C. to approximately 800° C.

20. The composition of claim 18, wherein the volatile component evaporates at a temperature greater than 800° C.
